(19) United States
(12) Patent Application Publication
(10) Pub. No.: US 2012/0011356 A1
(43) Pub. Date: Jan. 12, 2012

(54) COMMUNICATION DEVICE

(75) Inventors: Takeshi ISHIHARA, Kanagawa (JP); Nobuhiko Sugasawa, Kanagawa (JP); Kenichi Taniuchi, Kanagawa (JP); Keisuke Mera, Kanagawa (JP); Yu Kaneko, Kanagawa (JP)

(73) Assignee: KABUSHIKI KAISHA TOSHIBA, Minato-ku (JP)

(21) Appl. No.: 13/186,545

(22) Filed: Jul. 20, 2011

Related U.S. Application Data
(63) Continuation of application No. PCT/JP2010/050181, filed on Jan. 8, 2010.

(30) Foreign Application Priority Data
Jan. 21, 2009 (JP) 2009-011271

(51) Int. Cl. G06F 9/00

(52) U.S. Cl. 713/100

(57) ABSTRACT

According to one embodiment, a communication device to be connected with an external device via a network includes a connection unit, a variable resistance unit, and a control unit. The connection unit is connected to the network. The variable resistance unit is connected to the connection unit such that a resistance value is detectable from the external device, the resistance value being variable. The control unit changes the resistance value according to an operation state.

### CROSS-REFERENCE TO RELATED APPLICATIONS

This application is a continuation of PCT international application Ser. No. PCT/JP2010/050181 filed on Jan. 8, 2010 which designates the United States, and which claims the benefit of priority from Japanese Patent Application No. 2009-011271, filed on Jan. 21, 2009; the entire contents of which are incorporated herein by reference.

### FIELD

Embodiments described herein relate generally to a communication device having a function of allowing another communication device, which shares a physical connection configuring a network, to acquire a state.

### BACKGROUND

Conventionally, in order to acquire a state of a node connected to a network with high degree of certainty, software such as an operating system that is in charge of an operation of the node is usually used. For example, there has been known a technique in which a command of inquiring a state is transmitted from one node using a transmission control protocol/Internet protocol (TCP/IP), and a node that has received the command decides a response value representing an internal state and transmits it as a reply using a TCP/IP.

This technique assumes that a TCP/IP process and a data link layer that supports the process are properly operating. For this reason, the state can be acquired only when the node normally operates.

In order to cope with the above problem, there has been suggested a technique in which in addition to a first processor that operates an operating system, a second processor that is low in power consumption is mounted, and while power of the first processor is in an OFF state, small software operated by the second processor transmits a response by proxy or activates the first processor (for example, see JP-A No. 2006-259906 (KOKAI)).

In IEEE 802.3af standard and Patent Literature 2, there has been suggested a technique capable of confirming the presence or absence of a resistance value inside a detection target node, which is connected with a detection node via a network, from the detection node via the network. According to this technique, information that can be remotely acquired is restricted, but it is possible to detect whether or not the detection target node is an apparatus that requires power feeding by a network cable, based on the resistance value.

However, in the technique of JP-A No. 2006-259906 (KOKAI), the second processor needs be constantly in an operating state. For this reason, there are problems in that necessary power consumption and the cost increase because plural processors are required.

In the technique of Japanese Patent No. 3895171, since a fixed resistance value that is previously set is detected, it is possible to detect only the fact that the detection target node is in a fixed state previously set in accordance with a design requirement. For this reason, it is difficult to judge which state the detection target node is in among plural states that dynamically change.

### BRIEF DESCRIPTION OF THE DRAWINGS

FIG. 1 is a block diagram illustrating an example of a configuration of a communication device according to a first embodiment;

FIG. 2 is a block diagram illustrating an example of a functional configuration including a software configuration that operates on a processor;

FIG. 3 is a sequence diagram illustrating the overall flow of a resistance control process according to the first embodiment;

FIG. 4 is a diagram illustrating an example of a network configuration of a communication system including a communication device;

FIG. 5 is a flowchart illustrating an example of a device control process of controlling a communication device using remote controller software;

FIG. 6 is a block diagram illustrating an example of a configuration of a communication device having an integrated resistance element according to a second modification of the first embodiment;

FIG. 7 is a block diagram illustrating an example of a configuration using a plurality of variable resistance units;

FIG. 8 is a block diagram illustrating an example of a configuration using a plurality of variable resistance units;

FIG. 9 is a block diagram illustrating an example of a configuration of a communication device according to a second embodiment;

FIG. 10 is a block diagram illustrating an example of a configuration of a communication device according to a modification of the second embodiment; and

FIG. 11 is a flowchart illustrating the overall flow of a resistance control process in the second embodiment.

### DETAILED DESCRIPTION

In general, according to one embodiment, a communication device to be connected with an external device via a network includes a connection unit, a variable resistance unit, and a control unit. The connection unit is connected to the network. The variable resistance unit is connected to the connection unit such that a resistance value is detectable from the external device, the resistance value being variable. The control unit changes the resistance value according to an operation state.

Hereinafter, exemplary embodiments of a communication device, a control method, and a control program will be described in detail with reference to the accompanying drawings.

### First Embodiment

A communication device according to a first embodiment includes a variable resistance element having a variable resistance value and performs control to change the resistance value of the variable resistance element according to an operation state.

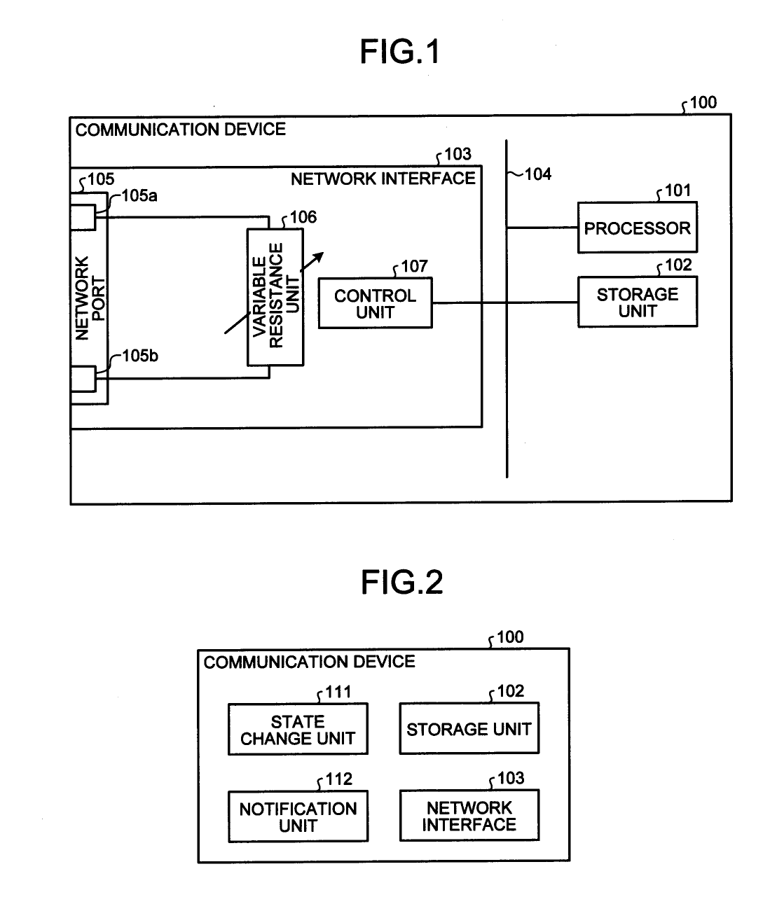

FIG. 1 is a block diagram illustrating an example of a configuration of a communication device 100 according to the first embodiment. As illustrated in FIG. 1, the communication device 100 includes a processor 101, a storage unit 102, a network interface 103, and a bus 104.

The bus 104 is a bus that connects components such as the processor 101, the storage unit 102, and the network interface 103 with one another.

The processor 101 controls an overall operation of the communication device 100. The storage unit 102 stores data and software that operates on the processor 101. The storage unit 102 may be configured by any generally used storage media such as a hard disk drive (HDD), an optical disk, a memory card, and a random access memory (RAM).

The network interface 103 is an interface for connecting the communication device 100 with a network to which an external device such as another communication device is connected. The network interface 103 includes a network port 105, a variable resistance unit 106, and a control unit 107.

The network port 105 is a port (a connection unit) for connecting a cable (not shown) physically connected with the network interface 103. The network port 105 includes a pair of pins 105a and 105b that are electrically connected with the variable resistance unit 106 so as to enable the resistance value of the variable resistance unit 106 to be detected. For example, when the network port 105 is a local area network (LAN) port that complies with Ethernet (registered trademark), any two of 8 pins may be used as the pins 105a and 105b.

The variable resistance unit 106 is an electrical resistance to which a plurality of resistance values varying continuously or discontinuously can be set. For example, the variable resistance unit 106 may be configured with a variable resistance element such as a magnetic tunnel junction (MTJ) element or a non-volatile digital potentiometer. The variable resistance unit 106 preferably has nonvolatility as a single element and can preferably store a changed resistance value without depending on a power state.

As described above, the variable resistance unit 106 is connected to the network through the pins 105a and 105b of the network port 105, and thus an external device connected to the network can detect the set resistance value.

The control unit 107 controls the variable resistance unit 106 to have a resistance value according to the operation state. The control unit 107 is designed according to the property of the variable resistance unit 106 to be applied and sets the resistance value of the variable resistance unit 106 to an appropriate value according to a control instruction from the outside.

For example, the control unit 107 receives the operation state of the communication device 100 as the control instruction, decides the resistance value according to the instructed operation state, and controls the variable resistance unit 106 to have the decided resistance value.

A correspondence relationship between the input operation state and the resistance value to be set needs to be implemented in the control unit 107. The relationship may be implemented by a static combinational circuit as a fixed correspondence relationship or may be implemented by software or the like so that the correspondence relationship can be changed. For example, a configuration may be such that a resistance value corresponding to a suspend state can be changed to a resistance value, which is instructed in some way, other than a fixed value decided at the time of design. The suspend state refers to a state in which an operation is performed at a minimum power consumption necessary for storing and maintain, for example, a work content in a memory (not shown).

In the present embodiment, software operating on the processor 101 issues the control instruction. FIG. 2 is a block diagram illustrating an example of a functional configuration including a software configuration that operates on the processor 101.

As illustrated in FIG. 2, the communication device 100 includes a state change unit 111 and a notification unit 112 as a main software configuration in addition to the storage unit 102 and the network interface 103 that are part of the hardware configuration.

The state change unit 111 changes the operation state of the communication device 100. For example, the state change unit 111 performs predetermined processing necessary for changing the operation state of the communication device 100 to the suspend state according to a suspend request notified from another software (not shown).

The notification unit 112 notifies the control unit 107 of the network interface 103 of the changed operation state changed by the state change unit 111 as the control instruction. As described above, the control unit 107 decides the resistance value of the variable resistance unit 106 according to the notified operation state.

The notification unit 112 may be configured to directly notify the resistance value according to the changed operation state as the control instruction. In this case, the control unit 107 may control the variable resistance unit 106 to have the notified resistance value.

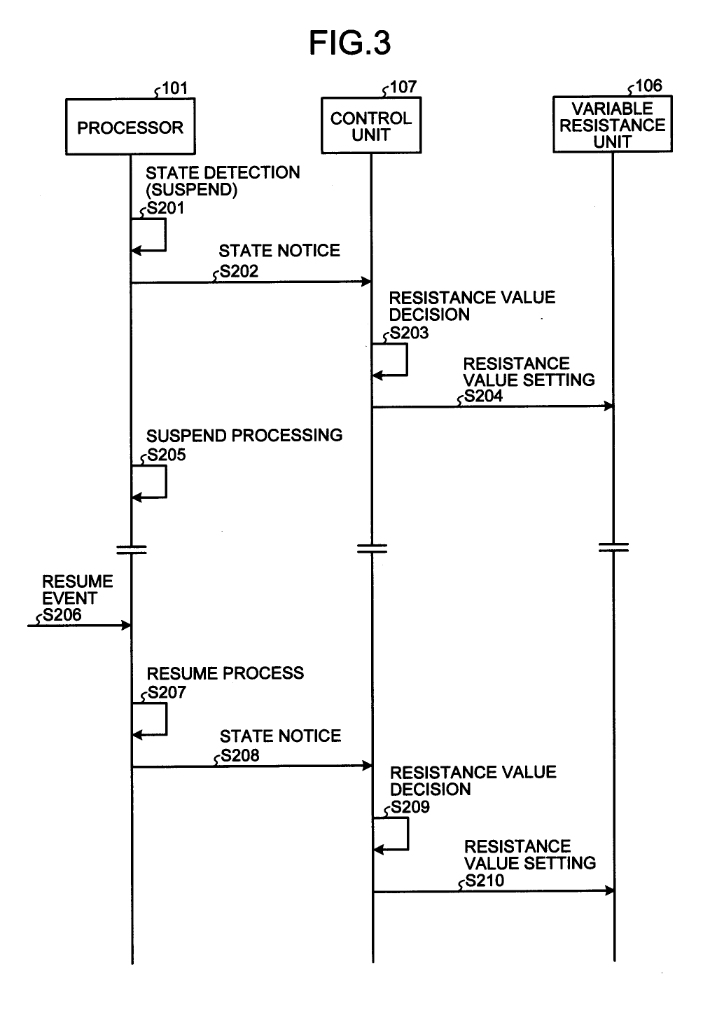

Next, a resistance control process by the communication device 100 having the above described configuration according to the first embodiment will be described with reference to FIG. 3. FIG. 3 is a sequence diagram illustrating the overall flow of the resistance control process according to the first embodiment.

FIG. 3 assumes that the communication device 100 is in a state in which it operates as usual (hereinafter, referred to as “normal operation state”). In the sequence of FIG. 3, a description will be made in connection with the flow until the communication device 100 receives a resume request from the outside and then resumes back to the normal operation state after it transitions from the normal operation state to the suspend state.

The state change unit 111 operated by the processor 101 detects a suspend request notified from an external processing unit such as another software (Step S201). As a result, the state change unit 111 start executing various processing necessary for transitioning to the suspend state (hereinafter, referred to as “suspend process”).

During a series of suspend processes, the notification unit 112 operated by the processor 101 notifies the control unit 107 of a new state. Here, the “suspend state” is notified to the control unit 107 as the new state (Step S202).

The control unit 107 derives the resistance value according to the notified operation state by using the correspondence relationship between the operation state and the resistance value that is implemented therein (Step S203). When the resistance value is derived, the control unit 107 controls the variable resistance unit 106 to have the derived resistance value (Step S204). Thereafter, the state change unit 111 continues another suspend process and finally the communication device 100 transitions to a suspend state (Step S205).

In this state, the variable resistance unit 106 is storing the resistance value representing that it is in the “suspend state.” Thus, by executing processing of inquiring the communication device 100 about the operation state and detecting the stored resistance value, another communication device connected via the network can appropriately acquire the fact that the operation state of the communication device 100 in the “suspend state.”

Next, it is assumed that a resume signal is notified from the outside during suspension. The resume signal refers to a signal that requests to resume from the “suspend state” to the “normal operation state.” The resume signal is, for example, a resume event notified by the operating system when a predetermined key is pressed down during suspension. The state change unit 111 detects the resume signal (Step S206) and starts processing for resuming to the “normal operation state” (hereinafter, referred to as “resume process”) (Step S207).

Next, the notification unit 112 notifies the control unit 107 of the “normal operation state” as the new state (Step S208). The control unit 107 that has been notified decides the resistance value corresponding to the “normal operation state” (Step S209) and sets the resistance value of the variable resistance unit 106 (Step S210).

In this state, the variable resistance unit 106 is storing the resistance value representing that it is in the “normal operation state.” Thus, by executing processing of inquiring the communication device 100 about the operation state and detecting the stored resistance value, another communication device can appropriately acquire the fact that the operation state of the communication device 100 in the “normal operation state.”

The sequence of FIG. 3 has been described in connection with the example in which the communication device 100 has two operation states including the “suspend state” and the “normal operation state,” but the operation state is not limited thereto. For example, an operation state may represent a “dormant state (suspend to disk or hibernation) or a “power OFF state.”

The number of operation states is not limited to two kinds. For example, implementation can be made to support all operation states including the “normal operations state,” the “suspend,” the “dormant state,” and the “power OFF.”

The communication device 100 may be implemented by a general personal computer or the like. However, an applicable device is not limited thereto, and may be any devices connectable to a network. For example, applicable devices include a peripheral device (a network attached storage (NAS), a printer, or the like) of a personal computer, an information home appliance (a television, a hard disk recorder, an air conditioner, lighting, or the like), and a security device connected to a network (a security camera, an electric key, or the like).

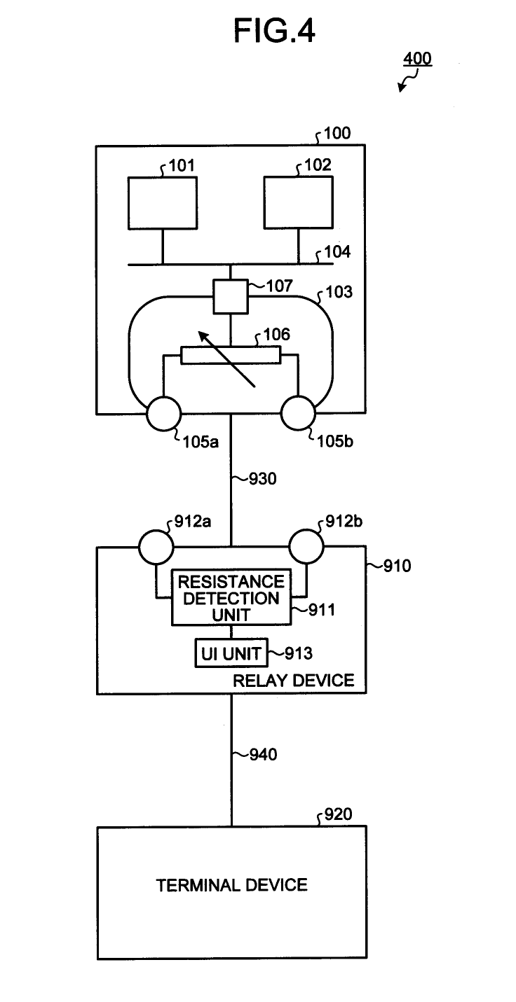

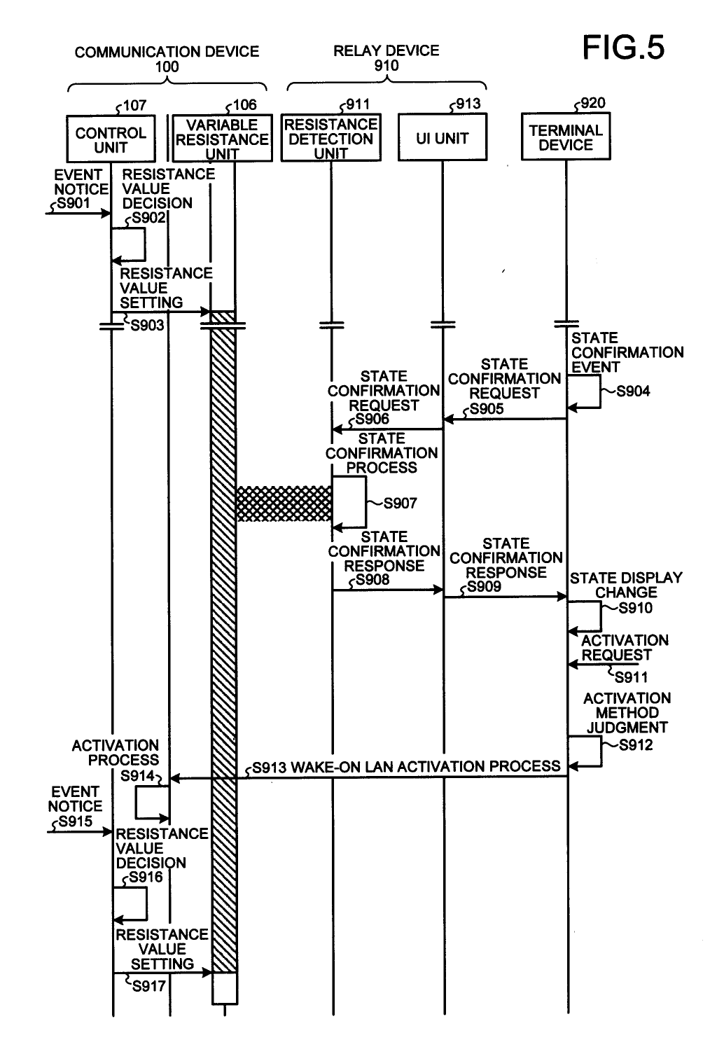

Next, a specific example of using the communication device 100 of the present embodiment in a network will be described. FIG. 4 is a diagram illustrating an example of a network configuration of a communication system 400 including the communication device 100. As illustrated in FIG. 4, the communication system 400 includes the communication device 100, a relay device 910, and a terminal device 920.

The relay device 910 is a device having a function of detecting the operation state of the communication device 100. The relay device 910 is connected with the communication device 100 through a communication path 930 such as a wire-line local area network (LAN).

The terminal device 920 is a device that actually attempts to acquire the operation state of the communication device 100 using the relay device 910. The terminal device 920 is connected with the relay device 910 through a communication path 940 such as a wire-line LAN or a wireless LAN.

In FIG. 4, other devices that are not necessary for the explanation below are omitted; however, more terminal devices or communication devices may be connected.

The relay device 910 includes a resistance detection unit 911, pins 912a and 912b of a network port (not shown), and a user interface (UI) unit 913 as main internal components.

The resistance detection unit 911 remotely detects the resistance value of the variable resistance unit 106 of the communication device 100. The pins 912a and 912b are a pair of pins respectively corresponding to the pins 105a and 105b of the communication device 100 among pins of the network port that connects a physical LAN cable.

The UI unit 913 provides the terminal device 920 with the user interface. The UI unit 913 may be implemented by a dedicated circuit or device, by a general-purpose processor and software, or by a combination thereof.

An internal component of the terminal device 920 is not shown but may employ the same configuration as a general personal computer.

In order to simplify the drawing, a line connecting the communication device 100 with the network port of the relay device 910 is not shown. For example, the communication path 930 and the communication path 940 are connected with the network port according to a standard to be used such as IEEE 802.3.

The communication device 100 has the configuration illustrated in FIG. 1. For this reason, the relay device 910 that is physically connected directly with the communication device 100 can detect the operation state of the communication device 100 by detecting the resistance value of the variable resistance unit 106 of the communication device 100. The relay device 910 includes the UI unit 913 having a user interface function that allows an operation from another device. Here, a description will be made under the assumption that a web server is arranged, and the user interface is provided to the terminal device 920 having a web browser or a dedicated application using a Hyper Text Transfer Protocol (HTTP). The user interface function is not limited thereto but may include a character-based user interface, an interface by a button or a light emitting diode (LED), or the like.

It is assumed that remote controller software that remotely controls the communication device 100 is installed in the terminal device 920. A user of the terminal device 920 controls the communication device 100 arranged at a physically remote position using the remote controller software. It is assumed that the remote controller software has a function of displaying the operation state of the target communication device 100 (power ON, wake-on LAN support suspend, wake-on LAN non-support suspend, and power OFF) and a function of controlling the power according to the state.

The wake-on LAN refers to a function of activating an external device, which is connected via a network, through a network. The “wake-on LAN support suspend” represents the suspend state that can be resumed by the wake-on LAN function. The “wake-on LAN non-support suspend” represents the suspend state that cannot be resumed by the wake-on LAN function.

FIG. 5 is a flowchart illustrating an example of a device control process of controlling the communication device 100 using the remote controller software.

Here, it is assumed that the communication device 100 is in the wake-on LAN support suspend state. That is, in response to an event notice (Step S901), the control unit 107 operates, decides a value representing the “wake-on LAN support suspend” as the resistance value of the variable resistance unit 106 (Step S902), and sets the value to the variable resistance unit 106 (Step S903).

In FIG. 5, a hatched rectangle of a rectangle below the variable resistance unit 106 represents that the variable resistance unit 106 has been set to the “wake-on LAN support suspend” state. A non-hatched rectangle represents the variable resistance unit 106 has been set to the “power ON” state.

If the remote controller software is operated by the terminal device 920, a state confirmation event takes place (Step S904). When the event takes place, the terminal device 920 transmits a state confirmation request to the UI unit 913 (the web server) operated by the relay device 910 (Step S905).

The UI unit 913 that has received the state confirmation request from the terminal device 920 requests the resistance detection unit 911 to acquire the resistance value of the variable resistance unit 106 of the communication device 100 based on the request (Step S906).

The resistance detection unit 911 detects the resistance value of the variable resistance unit 106 disposed in the communication device 100 by applying a predetermined amount of voltage or current to a cable connected to the pins 912a and 912b of the network port of the relay device 910 (Step S907). A hatched portion between the variable resistance unit 106 and the resistance detection unit 911 represents a resistance value detection period.

When the detection period is finished, the resistance detection unit 911 transmits the detected resistance value to the UI unit 913 (Step S908). Similarly, the UI unit 913 transmits a response to the terminal device 920 (Step S909).

As a result of a series of processes, the remote controller software of the terminal device 920 that has received the operation state of the communication device 100 can show the acquired operation state to the user (Step S910). As a result, the user can confirm that the communication device 100 is in the state of the “wake-on LAN support suspend.”

Here, it is assumed that the user has performed an operation of turning on the power of the communication device 100 using the remote controller software (Step S911). As a result, the remote controller software selects a remote activation process that conforms to the state of the communication device 100 acquired in the previous step (Step S912). Since it has been judged that the communication device is in the state of the “wake-on LAN support suspend,” a wake-on LAN activation process is selected and executed (Step S913).

As a result, the activation process is performed, and so the communication device 100 is powered on (Step S914). In this process, an event representing that the power has been turned on is notified to the control unit 107 (Step S915). Thereafter, the control unit 107 decides a resistance value to be set (Step S916) and sets the decided resistance value to the variable resistance unit 106 (Step S917).

Even though not shown in FIG. 5, after the above step is executed, if the terminal device 920 acquires the state of the communication device 100 again, it is possible to properly acquire the fact that the device is in operation (power ON). The user can confirm that the display representing the operation state of the communication device 100 has been updated to the “power ON” and then appropriately access and operate the communication device 100. Even if the communication device 100 cannot be accessed, since it has been confirmed that the communication device 100 has been activated, troubleshooting can be easily performed.

In a conventional method, the operation state of the communication device 100 cannot be properly judged by the state confirmation process (Step S904). For example, when the communication device is suspend in the state in which the wake-on LAN is supported, the power ON state and the suspend state are treated as the same state (a link-up state). When the communication device is suspend in the state in which the wake-on LAN is not supported, the power OFF state and the suspend state are treated as the same state (a link down state). For this reason, the operation state could not be judged unless the activation process by the wake-on LAN is performed. Thus, it is difficult to appropriately acquire the operation state of the communication device 100 from the remote site.

In contrast, according to the method of the present embodiment, the operation state of the communication device 100 can be clearly discriminated as described above. As a result, the remote controller software can remotely perform the activation process with a high degree of certainty only in the case of the suspend state in which the wake-on LAN is supported. Further, when it is in the power OFF state or the wake-on LAN non-support suspend state, the fact is displayed, so that the user can be encouraged to take an alternative action. Thus, the user's convenience is improved.

If the communication device 100 can be activated using different methods depending on the operation states, an appropriate method can be selected according to the operation state. For example, in the sequence of FIG. 5, since the suspend state in which the wake-on LAN is supported has been detected, the wake-on LAN activation process is executed. When the suspend state in which the wake-on LAN is not supported or the power OFF state has been detected, physically operating a mechanism for manipulating a power switch, turning on a breaker for supplying a mechanism with electricity, or transmitting an activation signal to a dedicated electric circuit that supplies power and activates the device may be performed.

(First Modification)

The description has been made in connection with the case in which an actual operation state of the communication device 100 matches with the resistance value of the variable resistance unit 106. However, the actual operation state needs not match with an operation state corresponding to the resistance value set to the variable resistance unit 106. For example, despite that the communication device 100 is in the normal operation state, the variable resistance unit 106 may be configured to represent the resistance value corresponding to the “suspend state’ or the “power OFF state.”

Here, it is assumed that another communication device (an opposing node) connected with the communication device 100 supports reading of the resistance value of the variable resistance unit 106 and performs communication control corresponding thereto. In the present modification, under the above assumption, the variable resistance unit 106 is intentionally controlled to have a resistance value different from the operation state of the communication device 100. As a result, for example, a configuration can be adopted in which a packet transmitted via a network, which otherwise is to be received, does not reach the network interface 103 of the communication device 100. Thus, it is possible to control power required for the network interface 103 or for the resistance control process, prevent an undesirable operation via a network, and allocate the capability of the processor 101 to another process.

For example, when a presentation is given using a notebook PC, a network connection needs not be continuously maintained. Thus, in this case, if the resistance value of the variable resistance unit 106 is set to a value corresponding to the “suspend state,” it can be expected that a packet is not transmitted from the outside and power consumption is reduced. Further, it is possible to prevent a reception notice of an electronic mail from being displayed or a reception notice of an instant message from being displayed during the presentation.

Another example can be considered in which a web page is browsed using the web browser where packets are transmitted in a burst manner and thereafter processing that does not use the network is mainly performed. In such an example in which the web browser is used, upon completion of page loading, the resistance value of the variable resistance unit 106 may be changed to a value corresponding to the “suspend state,” so that power consumption or reception of a useless packet can be suppressed during the page browsing by the user.

Similarly, in the situation where software that expect packet reception does not operate or the software does operate but does not expect packet reception by a specific network interface, and in the situation where packet reception is not allowed by firewall software or the like, power consumption or reception of a useless packet can be suppressed by intentionally changing the resistance value set to the variable resistance unit 106.

Such control may be implemented by software that operates on the processor 101. For example, the notification unit 112 may be configured to notify the control unit 107 of the operation state, which is designated by the user, other than an actual operation state. For example, the notification unit 112 may be configured to select an operation state to be notified from the operation state of the communication device 100 and the operation state of software that is being executed and notify the control unit 107 of the selected operation state.

(Second Modification)

As described above, the variable resistance unit 106 may be configured with a variable resistance element such as an MTJ element or a variable resistance device. In many cases, in the element or device, a resistance component is integrally formed with a control interface.

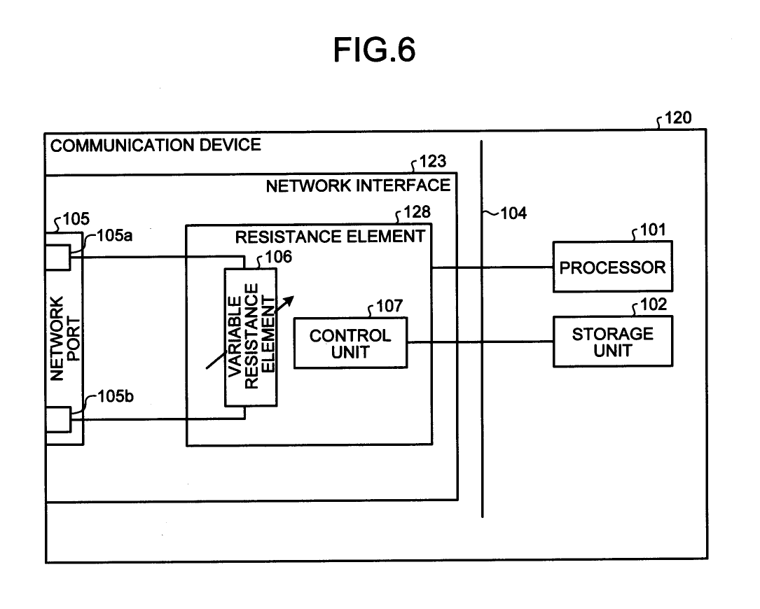

FIG. 6 is a block diagram illustrating an example of a configuration of a communication device 120 having an integrated resistance element according to a second modification of the first embodiment. As illustrated in FIG. 6, the communication device 120 includes a processor 101, a storage unit 102, a network interface 123, and a bus 104.

The present modification is different from the first embodiment in that the network interface 123 includes a resistance element 128 in which the variable resistance unit 106 of the first embodiment is integrated with the control unit 107. A control signal exchanged between the variable resistance unit 106 and the control unit 107 is processed inside the resistance element 128.

In the case of using the MTJ element, the control unit 107 controls a direction of a magnetic field stored in the resistance element 128. As a control method, there may be used a general method of operating the MTJ element such as a method of allowing an electric current to flow through a conductor close to the resistance element 128.

(Third Modification)

When a desired resistance value is not obtained by a single variable resistance unit 106, a plurality of variable resistance units may be coupled and used. For example, it is known that the MTJ element has two values including a high resistance value and a low resistance. For this reason, when three or more states are discriminated using the MTJ element as the variable resistance element, a plurality of MTJ elements need be arranged in series to derive a desired resistance value.

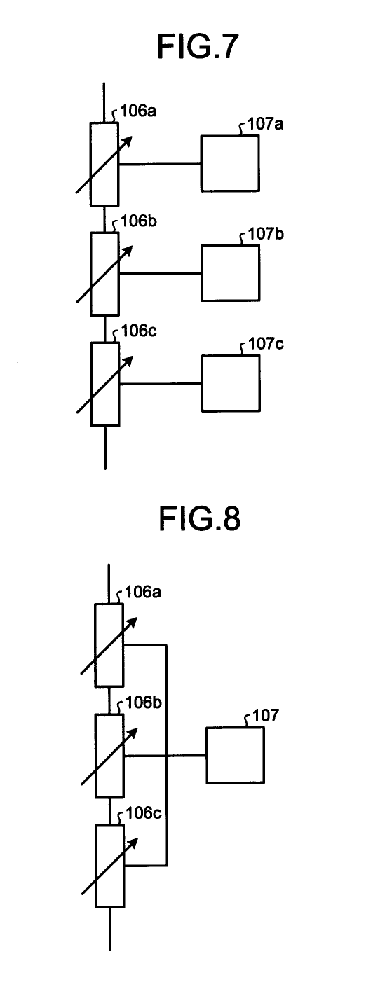

FIGS. 7 and 8 are block diagrams illustrating an example of a configuration using a plurality of variable resistance units. FIG. 7 illustrates an example in which a control unit and a variable resistance unit are mounted in one-to-one correspondence manner. In the example of FIG. 7, three variable resistance units 106a to 106c are controlled by control units 107a to 107c, respectively.

FIG. 8 illustrates an example in which a plurality of variable resistance units are mounted to be controlled by one control unit. In the example of FIG. 8, three variable resistance units 106a to 106c are controlled by one control unit 107.

Further, in the case of using a digital potentiometer, a connection needs be made in a form that conforms to a control interface of a digital potentiometer to be used. For example, a digital potentiometer may be one that supports a complicated input method such as a serial or I2C bus or may be one that supports a simple pulse input.

If a general-purpose digital potentiometer is used, an interface, which receives a parameter that is not specific and is dependent on a used system, may not be used. Generally, most of interfaces receive a resistance value or a parameter corresponding directly to a resistance value as an input.

In this case, it is preferable to perform a work of changing information (for example, an instruction output from the processor 101 or an event notice generated by a sensor) generated inside the communication device 100 to information that conforms to an input interface of the digital potentiometer by using software that operates on the processor 101 or a new dedicated conversion circuit.

(Fourth Modification)

In the above description, the operation state of the communication device 100 is expressed using the variable resistance element that appears as one element logically. In this method, there is an advantage capable of reducing the number of parts, but the resistance value needs be strictly controlled. Thus, a configuration may be adopted in which a variable resistance element and a reference resistance element that is an element having a predetermined reference resistance value are used. An operation state can be detected based on a resistance value difference between the resistance elements or a potential difference that is caused by the resistance value difference. For example, it may be implemented by connecting the reference resistance element to one pair of a LAN cable and the variable resistance element to another pair.

As described above, in the communication device 100 according to the first embodiment, a variable resistance element having a variable resistance value is installed, and thus control can be performed to change the resistance value of the variable resistance element according to the operation state. Accordingly, standby power for implementing confirmation of the operation state can be reduced, and the external device can acquire various operation states that change according to the operation of the device.

A control program executed by the communication device 100 according to the first embodiment is a file of an installable or executable format and is provided as being recorded on a computer readable recording medium such as a compact disk read only memory (CD-ROM), a flexible disk (FD), a compact disk recordable (CD-R), and a digital versatile disk (DVD).

Further, the control program executed by the communication device 100 according to the first embodiment may be stored in a computer connected to a network such as the Internet and provided as being downloaded via a network. Further, the control program executed by the communication device 100 according to the first embodiment may be provided or distributed via a network such as the Internet.

Further, the control program according to the first embodiment may be provided as being incorporated into a read only memory (ROM) or the like in advance.

The control program executed by the communication device 100 according to the first embodiment has a module configuration including the above described components (the state change unit and the notification unit). In actual hardware, by reading out and executing the control program from the storage medium through the processor 101, the above-described components are loaded onto a main storage device, so that the above described components are generated on the main storage device.

### Second Embodiment

A communication device according to a second embodiment includes a sensor device that detects various kinds of information related to an operation state and performs control to change a resistance value of a variable resistance element according to the detection result.

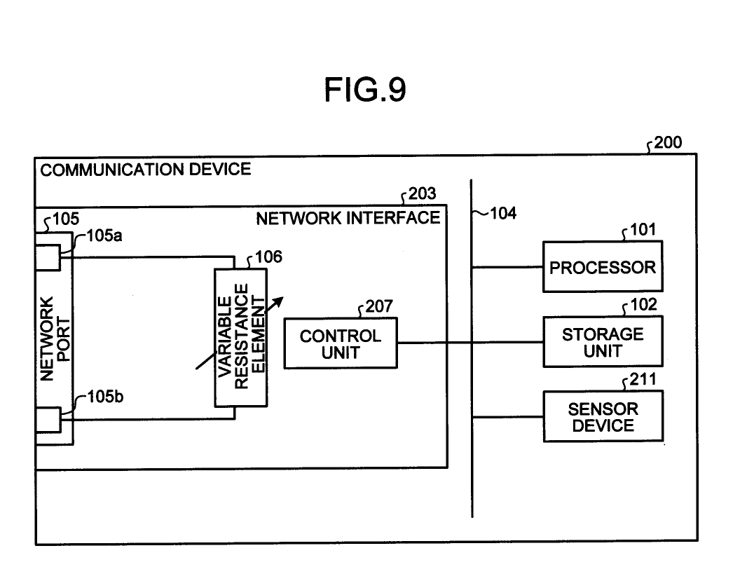

FIG. 9 is a block diagram illustrating an example of a configuration of a communication device 200 according to the second embodiment. As illustrated in FIG. 9, the communication device 200 includes a processor 101, a storage unit 102, a network interface 203, a bus 104, and a sensor device 211.

The second embodiment is different from the first embodiment in that the sensor device 211 is added, and a control unit 207 of the network interface 203 has a different function. The remaining configurations and functions are the same as in FIG. 2 that is a block diagram illustrating the configuration of the communication device 100 according to the first embodiment and denoted by the same reference numerals, and thus a description thereof is not repeated.

The sensor device 211 may be a sensor that detects a change in the operation state that takes place in the communication device 200 or may be a sensor that requests the operation state to be changed. For example, when the communication device 200 is implemented by a notebook PC, an opening/closing sensor attached to a liquid crystal display (LCD) of the notebook PC may be used as the sensor device 211. Further, a configuration may be adopted to use a current sensor for measuring a current flowing through the processor 101, a voltage sensor for measuring a voltage of the processor 101, a temperature sensor for measuring an amount of heat generated from the processor 101, a pressure sensor corresponding to a power button, an optical sensor for recognizing an amount of light around the communication device, or a sound sensor for recognizing a sound.

The control unit 207 is different from the control unit 107 of the first embodiment in that the resistance value of the variable resistance unit 106 is set according to the detection result of the sensor device 211.

In FIG. 9, one sensor device is illustrated, but kinds and the number of sensor devices that are mounted at the same time are not limited to one. A plurality of sensor devices may be mounted at the same time, and a plurality of sensor device of the same kind may be mounted.

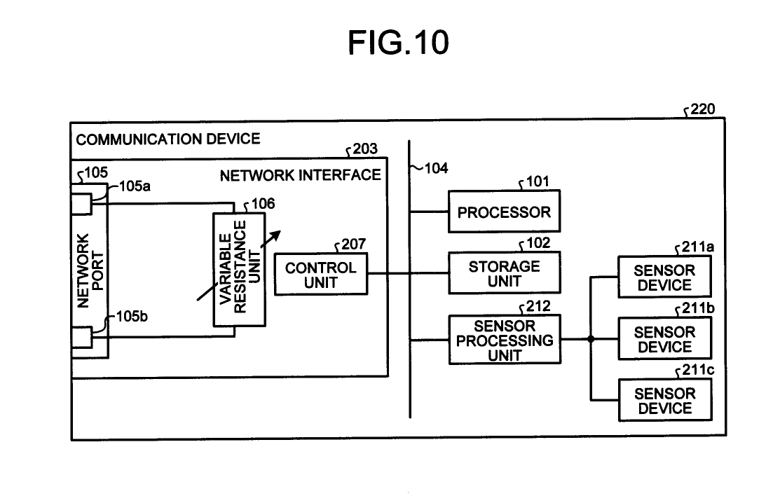

Further, a configuration may be adopted in which a plurality of sensor devices are installed, and a configuration may be adopted to decide a control instruction notified to the control unit 207 according to information from the sensor devices. FIG. 10 is a block diagram illustrating an example of a configuration of a communication device 220 having the above-described configuration. As illustrated in FIG. 10, a communication device 220 includes a processor 101, a storage unit 102, a network interface 203, a bus 104, a plurality of sensor devices 211a to 211c, and a sensor processing unit 212.

The sensor processing unit 212 functions as a judgment unit that judges whether or not the operation state of the communication device 220 is to be changed based on information output from the sensor devices 211a to 211c. When it is judged to be changed, the sensor processing unit 212 notifies the control unit 207 of an appropriate signal that conforms to the operation state to change instead of the sensor devices 211a to 211c.

Further, in the case of utilizing a plurality of sensor devices, a component such as the sensor processing unit 212 that collects information of the sensor devices is not essential. For example, the control unit 207 may be configured to judge the resistance value to be set based on inputs from the sensor devices.

A case in which the communication device 200 of FIG. 9 is implemented by a notebook PC and the sensor device 211 that is a sensor for detecting the opening/closing state of the LCD of the notebook PC is attached will be described below as an example.

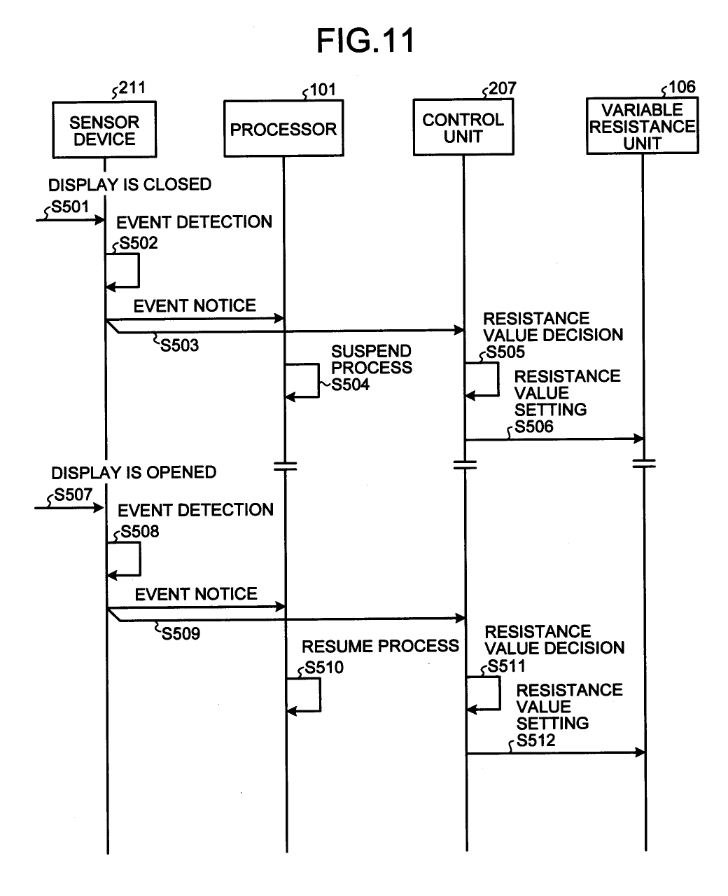

A resistance control process by the communication device 200 having the above described configuration according to the second embodiment will be described with reference to FIG. 11. FIG. 11 is a flowchart illustrating the overall flow of the resistance control process in the second embodiment.

It is assumed that a sequence of FIG. 11 starts in a state in which a notebook PC is being used (a normal operation state).

First, it is assumed that the user of the notebook PC has stopped his/her work and then closed the display of the notebook PC (Step S501). The sensor device 211 detects the operation (Step S502). The sensor device 211 notifies the processor 101 and the control unit 207 of the fact that the display has been closed (Step S503).

The processor 101 that has received the notice executes the suspend process by processing of software operating on the processor 101 (Step S504). It is assumed that the event notice and execution of processing according to the event by the processor 101 are implemented by a method that has been conventionally used.

The control unit 207 that has received the notice decides the resistance value corresponding to the notified event (in this case, “the display has been closed”) (Step S505). Thereafter, the control unit 207 controls the variable resistance unit 106 and sets the decided resistance value (Step S506).

This is the flow of processing until the variable resistance value is set after an event causing the state to change is detected. In the present sequence, the suspend process generated by software operating on the processor 101 and the resistance value change process by the control unit 207 are executed in parallel. As described above, in the present embodiment, control of the variable resistance unit 106 can be implemented without changing existing software. That is, in the present embodiment, it is not necessary to execute control by software operating on the processor 101 as in the first embodiment. Similarly to the first embodiment, for example, the function of the sensor processing unit 212 may be implemented by software operating on the processor 101.

Subsequently, a description will be made in connection with processing when a user restarts his/her work. In this case, an operation of opening the display becomes a starting point (Step S507). The sensor device 211 detects that the display is opened (Step S508) and notifies the processor 101 and the control unit 207 of the fact (Step S509).

The processor 101 that has received the notice executes a resume process by software operating on the processor 101 (Step S510). Similarly, the control unit 207 that has received the notice decides the resistance value corresponding to the notified event (in this case, “the display is opened”) (Step S511). Thereafter, the control unit 207 controls the variable resistance unit 106 and sets the decided resistance value (Step S512).

This is the sequence of the resistance control process in the second embodiment. In the present sequence, the example of using the opening/closing sensor of the display attached to the notebook PC is described, but the above sequence may be implemented using any other sensor described above.

For example, a desktop PC or an information home appliance does not use the opening/closing sensor. These devices may be configured to use the temperature sensor of the processor 101, the current sensor, the voltage censor, or the like. In this case, an event detected by the sensor does not cause the operation state to change, and attention needs be paid to detecting a physical change caused by a change in the operation state through a corresponding sensor. For example, after suspension is executed by software operating on the processor 101, a change in a parameter such as a temperature, current, or a voltage of the processor 101 is observed. Thus, after a change in the actual operation state has taken place (Step S504 or Step S510) and then a physical change corresponding to the change in the operation state has taken place, processing of changing the resistance value according to the changed physical change (Step S502 to Step S506 or Step S508 or Step S512) is executed.

As described above, in the communication device 200 according to the second embodiment, the sensor device for detecting various kinds of information related to the operation state is installed, and control can be performed to change the resistance value of the variable resistance element according to the detection result. Thus, standby power for implementing confirmation of the operation state can be reduced, and an external device can acquire various operation states changed according to an operation of the device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication device to be connected with an external device via a network, comprising:
a connection unit that is connected to the network;
a variable resistance unit that is connected to the connection unit such that a resistance value is detectable from the external device, the resistance value being variable; and
a control unit that changes the resistance value according to an operation state.

2. The communication device according to claim 1,
further comprising a state change unit that changes the operation state,
wherein the control unit changes the resistance value according to the changed operation state.

3. The communication device according to claim 2,
further comprising a notification unit that notifies the control unit of the changed operation state,
wherein the control unit changes the resistance value according to the notified operation state.

4. The communication device according to claim 2,
further comprising a notification unit that notifies the control unit of the resistance value corresponding to the changed operation state,
wherein the control unit changes the variable resistance unit to have the notified resistance value.

5. The communication device according to claim 1,
further comprising a detection unit that detects a physical change that takes place in the communication device according to a change in the operation state,
wherein the control unit changes the resistance value according to the detected physical change.

6. The communication device according to claim 5,
further comprising a judgment unit that judges whether or not the resistance value is to be changed based on the detected physical change,
wherein the control unit changes the resistance value according to the detected physical change when it is judged that the resistance value is to be changed.

7. The communication device according to claim 3,
wherein a plurality of the variable resistance units are provided, and
the control unit changes each of the variable resistance units to have the resistance value according to the operation state.

8. The communication device according to claim 7,
wherein the control units are provided for the variable resistance units, respectively and each of the control units changes the corresponding variable resistance unit to have the resistance value according to the operation state.
